(19) United States
(12) Patent Application Publication
(10) Pub. No.: US 2013/0342057 A1
(43) Pub. Date: Dec. 26, 2013

(54) LINEAR-ROTATING MAGNET ENERGY HARVESTER

(71) Applicant: Max B. Fried, Burlington, VT (US)

(72) Inventor: Max B. Fried, Burlington, VT (US)

(73) Assignee: LORD Corporation, Cary, NC (US)

(21) Appl. No.: 13/980,169

(22) PCT Filed: Jan. 17, 2012
(86) PCT No.: PCT/US2012/021537

§ 371 Date: Sep. 9, 2013

Related U.S. Application Data
(60) Provisional application No. 61/433,426, filed on Jan. 17, 2011.

(51) Int. Cl. H02K 7/065

(52) U.S. Cl. CPC H02K 7/065
USPC 310/80

(57) ABSTRACT

A device includes a first magnet, a second magnet, and a coil. The first magnet is constrained to move in substantially-linear motion. The second magnet is mounted to move in rotational motion. The first and second magnets are positioned so the substantially-linear motion of the first magnet causes rotation of the second magnet. The coil is adjacent the second magnet, and rotation of the second magnet induces a current in the coil.

### PRIORITY

This application claims the benefit of U.S. Provisional Patent Application 61/433,426, filed Jan. 17, 2011, “Linear-Rotating Magnet Energy Harvester,” incorporated herein by reference.

### FIELD

This patent application generally relates to a system for harvesting mechanical energy and converting it to electrical energy. More particularly it relates to a system for transforming vibratory motion into rotational motion of a magnet that induces current in a coil. It also relates to systems for converting vibratory motion of a magnet into electricity and for converting a supplied current into oscillation and rotation of magnets.

### BACKGROUND

Various schemes have been proposed to harvest mechanical energy from the environment, such as vibration, as described in commonly assigned U.S. Pat. Nos. 7,081,693, 7,256,505, both incorporated herein by reference, in commonly assigned U.S. patent application Ser. Nos. 12/761,259 and 13/038,339, both incorporated herein by reference, and in the paper, “Harvesting Power from Multiple Energy Sources for Wireless Sensors,” by Christopher P. Townsend, Michael J. Hamel, and Steven W. Arms, presented at the Fifth Energy Harvesting Workshop and Tutorial at the Roanoke, Va., Mar. 2-4, 2010 incorporated herein by reference. However, the amount of energy harvested has not been sufficient for many applications. Thus, better systems for harvesting mechanical energy and converting to electrical energy are needed, and these systems are provided by the present patent application.

### SUMMARY

One aspect of the present patent application includes a device that includes a first magnet, a second magnet, and a coil. The first magnet is constrained to move in substantially-linear motion. The second magnet is mounted to move in rotational motion. The first and second magnets are positioned so the substantially-linear motion of the first magnet causes rotation of the second magnet. The coil is adjacent the second magnet, and rotation of the second magnet induces a current in the coil.

Another aspect of the present patent application includes a device that includes a coil and a system for non-contact converting substantially-linear motion into rotational motion. The coil is positioned to convert the rotational motion into electricity.

Another aspect of the present patent application includes a device that includes a coil and a system for non-contact converting rotational motion into substantially-linear motion. The coil is positioned to convert the linear motion into electricity.

Another aspect of the present patent application includes a device, that includes a coil, a first magnet, a second magnet. The first magnet is constrained to move in substantially-linear motion. The second magnet is mounted to move in rotational motion. The first and second magnets are positioned so at least one from the group consisting of the substantially-linear motion of the first magnet causes rotation of the second magnet and the rotation of the second magnet causes the substantially-linear motion of the first magnet. The coil is positioned adjacent one from the group consisting of the first magnet and the second magnet.

### BRIEF DESCRIPTION OF THE DRAWINGS

FIG. 1 is a three dimensional view illustrating an assembly including a linear magnet mounted on a cantilever beam that can vibrate in substantially linear motion and which is located near a rotating magnet assembly that includes a rotating magnet mounted so it can rotate around an axis substantially parallel o the linear motion of the linear magnet;

FIG. 2a is a front view illustrating a rotating magnet in its rotating magnet holder with bearing rods and ball bearings connected to a housing of a rotating magnet assembly without the coil bobbin in place;

FIG. 2b is a three dimensional view illustrating the rotating magnet in its rotating magnet holder with bearing rods and ball bearings of FIG. 2a for connection to the housing of the rotating magnet assembly;

FIG. 3 is a front view illustrating the rotating magnet assembly of FIG. 2a with the coil bobbin in place;

FIG. 4 is a three dimensional view of another embodiment of a scheme for providing a linear magnet in which several linear magnets are mounted on a linear magnet holder that rotates to provide substantially linear motion near a rotating magnet assembly;

FIG. 5 is a three dimensional view of another embodiment of a scheme for providing a linear magnet in which several linear magnets are mounted on a conveyor belt that moves to provide substantially linear motion;

FIG. 6 is a three dimensional view illustrating an assembly similar to that of FIG. 1 in which a linear magnet is mounted on a parallelogram cantilever beam to provide substantially linear motion that is more linear than provided by a single cantilever beam;

FIG. 7 is a graph illustrating output voltage of the coil during operation of the assembly of FIG. 1 and showing the calculation of peak power generated;

FIG. 8 is a three dimensional view of the embodiment of the scheme of FIG. 9a for providing a linear magnet mounted with springs in a tube in which the linear magnet is located near several of the rotating magnet assemblies of FIG. 9a;

FIG. 9a is a three dimensional view of another embodiment of a scheme for providing a linear magnet in which the linear magnet is mounted with springs in a tube and the linear magnet is located near a rotating magnet assembly of FIG. 1;

FIGS. 10a- 19a and 10b-19b are views illustrating the magnetic fields of the linear magnet and the rotating magnet in different positions of the linear magnet and how vibratory movement of the linear magnet causes magnetic field interaction that causes rotation of the rotating magnet;

FIG. 20 is a three dimensional view of an embodiment similar to the scheme of FIG. 9a in which a coil is provided around the linear magnet so oscillation of the linear magnet causes an AC current to be generated within the coil around the linear magnet;

FIG. 21 is a three dimensional view of an embodiment similar to the scheme of FIG. 20 in which a motor drives rotation of the rotating magnet through an extended bearing rod, and rotation of the rotating magnet drives oscillation of the linear magnet within its coil, and this oscillation of the linear magnet causes an AC current to be generated within the coil around the linear magnet;

FIG. 22 is a three dimensional view of an embodiment similar to the scheme of FIG. 21 in which vibration causes oscillation of the linear magnet within its coil, and this oscillation of the linear magnet causes the rotating magnet to flip which causes the extended bearing rod to rotate which causes a generator or permanent magnet motor to generate electricity; and

FIG. 23 is a three dimensional view of an embodiment similar to the scheme of FIG. 20 in which an AC current is supplied to the coil surrounding the linear magnet which causes the linear magnet to oscillate which causes the rotating magnet to rotate which causes extended bearing rod and any device mounted to the extended bearing rod to rotate.

### DETAILED DESCRIPTION

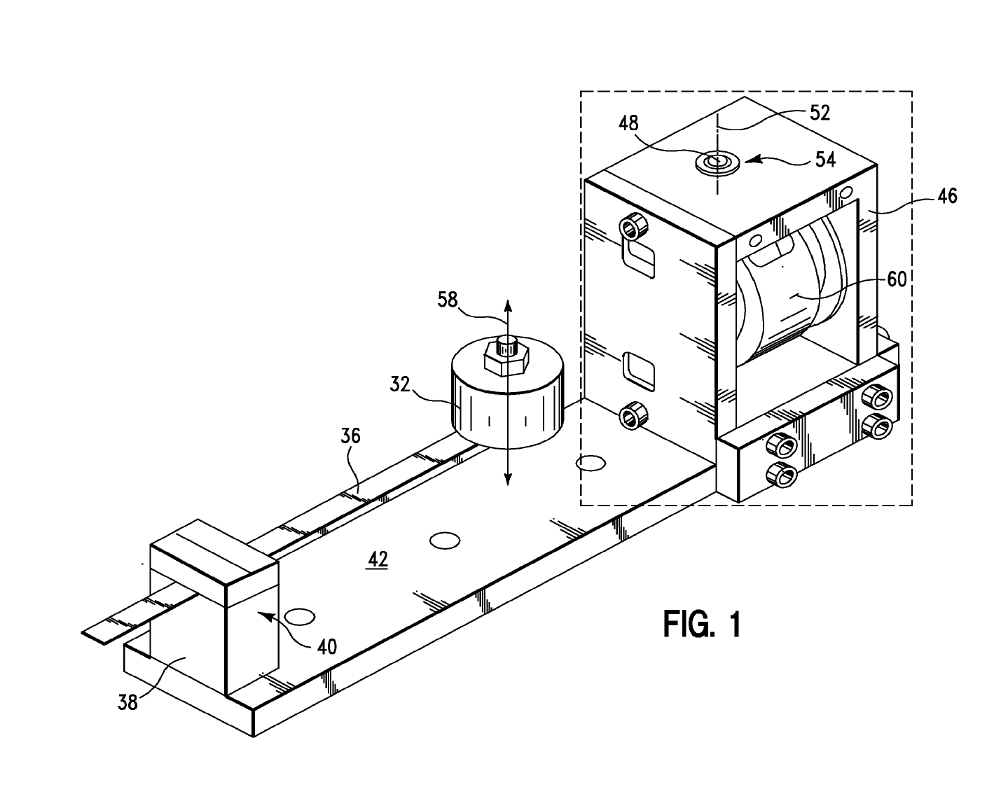

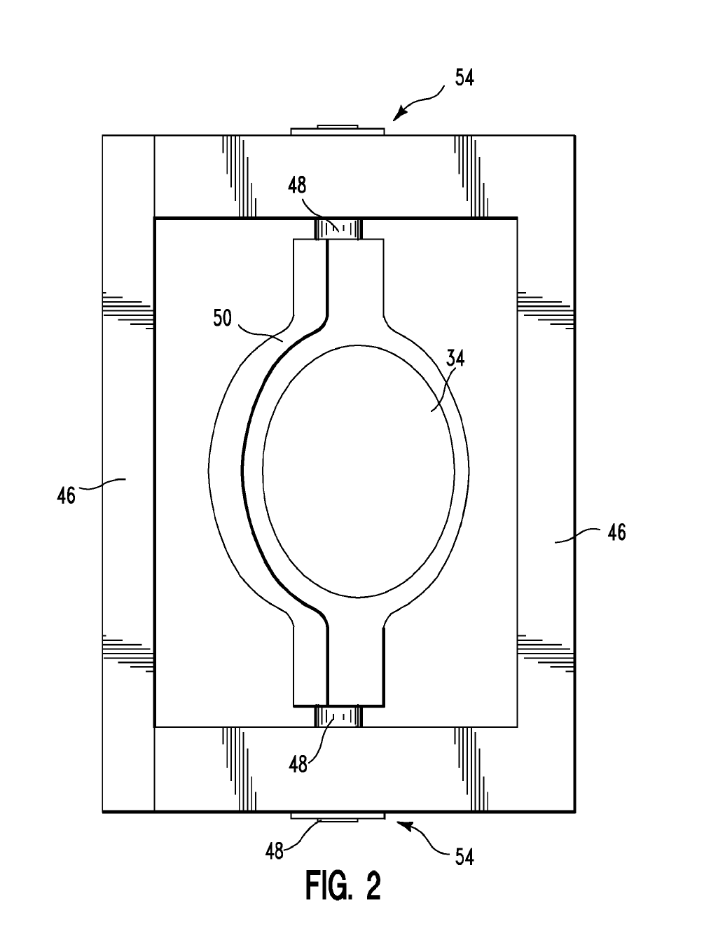

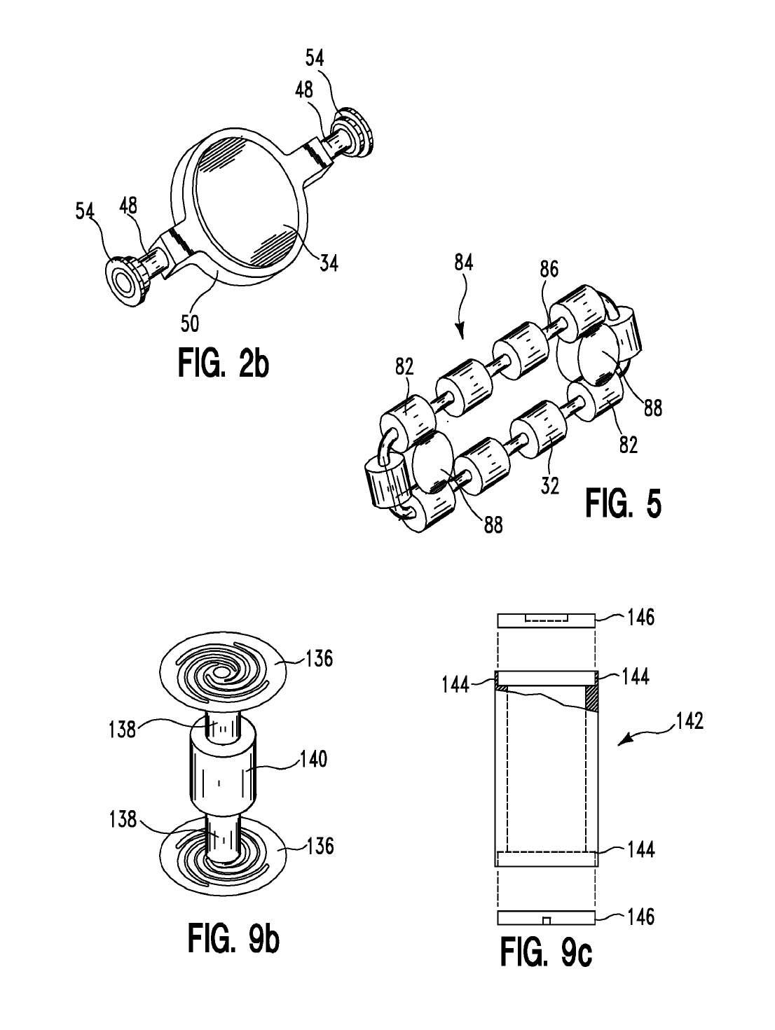

The present applicant built a device for harvesting mechanical energy and converting it into electrical energy. In one embodiment, prototype rotating magnet energy harvester device 30 included a pair of magnets, one magnet subject to vibrating movement called linear magnet 32 and the other capable of rotating movement called rotating magnet 34, as shown in FIGS. 1, 2a, 2b.

In prototype 30 built by the applicant, both magnets 32, 34 were neodymium, available from KJ Magnetic of strength N42. Linear magnet 32 had part number R824, had in inside diameter of ⅛ inch, an outside diameter of ½ inch, and a thickness of ¼ inch. Its mass was 5.66 g. Rotating magnet 34 had part number DC4, an outside diameter of ¾ inch a thickness of ¾ inch, and a mass of 13.6 g.

In prototype 30, linear magnet 32 was mounted to one end of cantilever beam 36 which was made of spring steel having a stiffness of 50 N/m. Cantilever beam 36 was clamped to cantilever beam support member 38 with cantilever beam clamp 40 and connected to mounting plate 42.

Rotating magnet 34 was mounted in rotating magnet assembly 44 that included housing 46 and that was also connected to mounting plate 42, as shown in FIGS. 1 and 2a. Bearing rods 48 supported magnet holder 50 that was holding rotating magnet 34. Bearing rods 48, magnet holder 50 and rotating magnet 34 could freely rotate around axis of rotation 52 within ball bearings 54 connected to housing 46. In prototype 30, rotating magnet 34 was press fit into magnet holder 50 that included a pair holes (not shown) for holding bearing rods 48.

Cantilever beam 36 and rotating magnet 34 were oriented so direction of vibration 58 of linear magnet 32 on cantilever beam 36 was substantially parallel to axis of rotation 52 of rotating magnet 34, as shown in FIG. 1.

Mounting plate 42, along with cantilever beam 36, linear magnet 32, and rotating magnet 34 were all subjected to vibration on a shaker (not shown), to which mounting plate 42 was attached. When tuned, linear magnet 32 mounted on cantilever beam 36 vibrated with a much larger displacement than the amplitude of vibration of the shaker and of housing 46 holding rotating magnet 34.

Linear and rotating magnets 32, 34 were positioned so the resulting relative displacement of linear magnet 32 as it vibrated created a magnetic field that shifted with time at the location of rotating magnet 34, causing rotating magnet 34 to rotate, as more fully described herein below.

For assembling prototype 30, ball bearings 54 were inserted in holes in housing 46 and bearing rods 48 were pressed through the ball bearings 54 into the holes in magnet holder 50 so magnet holder 50 with its magnet 34 and bearing rods 48 were held in housing 46 and could spin freely with ball bearings 54, as shown in FIG. 2a, 2b. Other low friction bearings, such as jewel bearings, can be used.

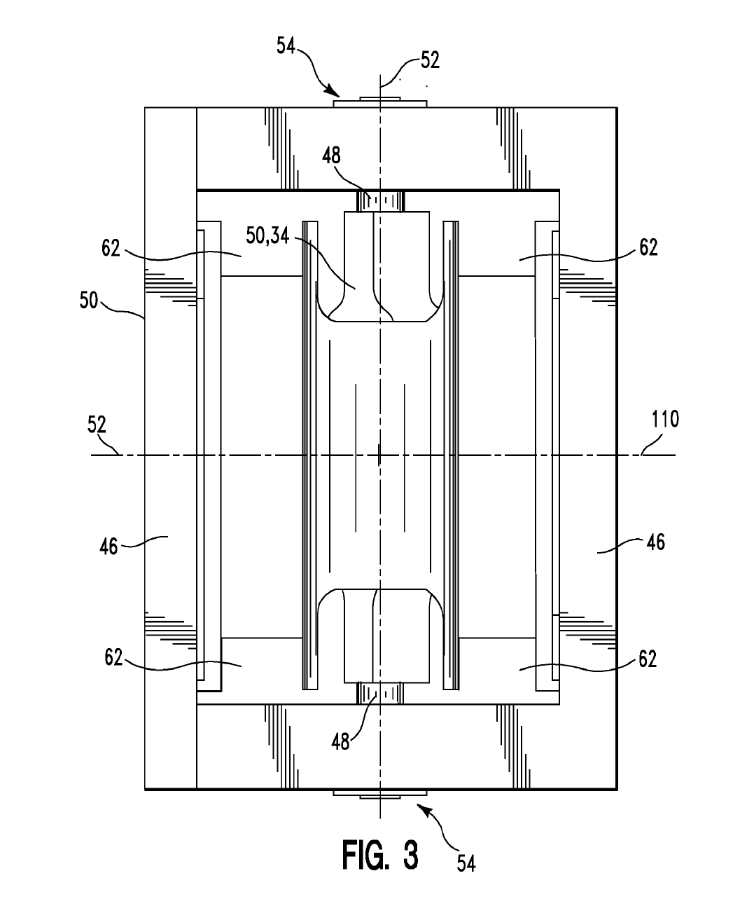

Prototype 30 also included coil bobbin 60 holding pair of coils 62, as shown in FIG. 3. In prototype 30, rotating magnet 34 was rotatably mounted between coils 62, each of which had a central opening (not shown) large enough for a portion of rotating magnet 34 to pass within as rotating magnet 34 rotated. Coil bobbin 60 also had openings top and bottom through which bearing rods 48 passed. The internal diameter of each coil 62 was 1.02 inch, the outside diameter was 1.37 inch, the thickness of coil 62 was 0.25 inch and included 3000 turns of 42 gauge wire. The distance between the two coils 62 was about 0.5 inch.

The rotation of rotating magnet 34 induced an electrical current in the windings (not shown) of coils 62. For testing, the current was passed from the windings through a resistive load (not shown) whose resistance was adjusted to match the impedance of coils 62. In prototype 30 a resistance box was used for the resistance, making adjustment easy. The present applicant tested the device by measuring the RMS voltage across the matched resistive load to determine the power produced.

In one embodiment of operating the prototype 30 on the shaker, the present applicant adjusted the length of cantilever beam 36 and the frequency and amplitude of vibration of the shaker until he saw that cantilever beam 36 was oscillating with a large amplitude, indicating it was in resonance, and that rotating magnet 34 was rotating rapidly in one direction.

Adjustable parameters, such as material, length and thickness of cantilever beam 36, mass of linear magnet 32 and mass of non-magnetic material mounted on cantilever beam 36, as well as the influence of nearby rotating magnet 34, determine the beam's natural frequency of vibration.

The present applicant also found that rotating magnet 34 rapidly flipped even if linear magnet 32 was, by hand, moved very slowly past rotating magnet 34.

As an alternative to dissipating electricity harvested in a resistive load for testing, the electricity could also be used to power any other load, such as an electronic circuit, or it could be stored in an electrical storage device, such as a capacitor or a battery. A circuit to rectify or regulate the electrical current can also be included.

Thus, a device, such as prototype rotating magnet energy harvester device 30, can be used to harvest energy by converting substantially-linear motion, such as that of linear magnet 32, into rotational movement of rotating magnet 34 and then converting the rotational energy of rotating magnet 34 into electrical energy in coil 62. That electrical energy can then be used by the load or stored.

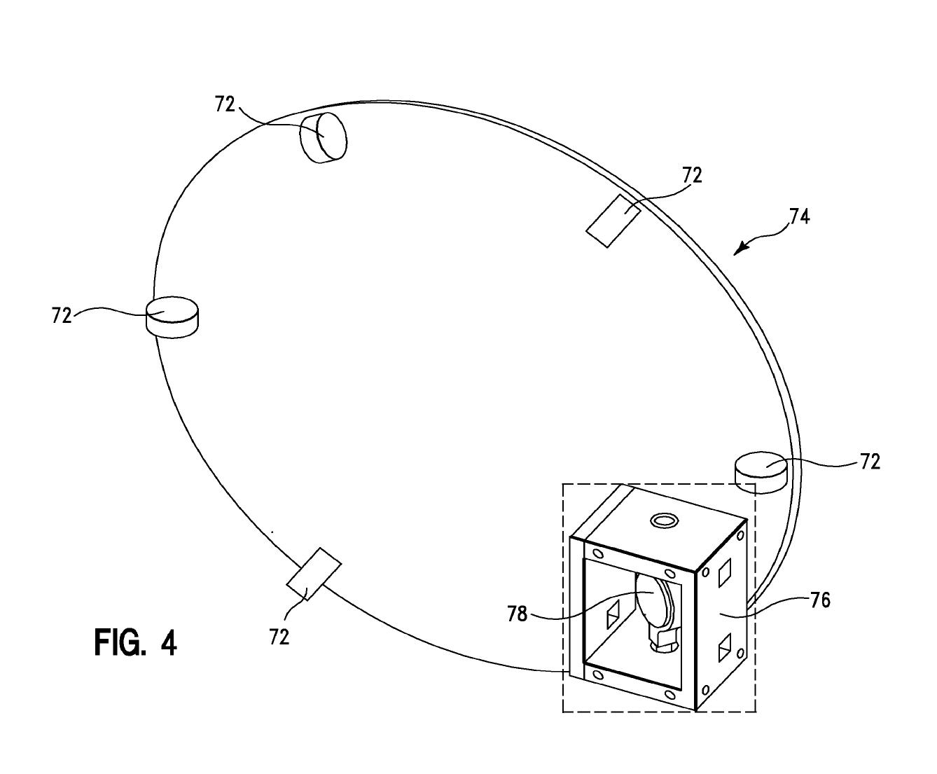

“Substantially-linear motion” includes vibratory motion, such as the vibratory motion of cantilever beam 36 in prototype 30. “Substantially-linear motion” also includes an arc segment of a pendulum (not shown). Though a cantilever beam and a pendulum's path is actually along a segment of a circle with a radius equal to the length of cantilever beam 36 or pendulum, as the beam or pendulum with linear magnet 32 mounted passes in the vicinity of rotating magnet 34, the arc segment along which it travels and along which it has an effect on rotating magnet 34 is close enough to linear that it may be considered to be substantially-linear motion. “Substantially-linear motion” also includes a portion of fully rotating motion, such as shown in FIG. 4 in which one or more linear magnets 72 are mounted on linear magnet holder 74 that rotates around in a circle, and each linear magnet 72 passes near housing 76 holding rotating magnet 78. As each linear magnet 72 so mounted passes in the vicinity of rotating magnet 78, the arc segment along which it travels, and along which it has an effect on rotating magnet 78, is close enough to linear that it may be considered substantially-linear motion. The rotating motion can be circular, as in FIG. 4, or it may be along another path, such as an elliptical path.

“Substantially-linear motion” also includes seemingly continuous motion along a straight line in one direction, as shown in FIG. 5, in which, for example, one or more linear magnets 82 are mounted on or form part of conveyor belt 84 and each linear magnet 82 passes near the housing (not shown) holding rotating magnet 34. As shown in FIG. 5 conveyor belt 84 includes conveyor links 86 connecting between linear magnets 82, and conveyor belt 84 is driven by pulleys 88.

Under some circumstances of relative magnet positioning and shaker frequency, the present applicant found that rotating magnet 34 of prototype 30 rotated 180 degrees and then rotated back. In other circumstances of relative magnet positioning, shaker frequency, and linear magnet amplitude, rotating magnet 34 rotated continuously in one direction. The present applicant found substantially greater power was generated when the alignment of linear magnet 32 with rotating magnet 34 and the frequency and amplitude of vibration of linear magnet 32 were right to produce continuous rotation of rotating magnet 34 in one direction. In addition to their relative position, the frequency of vibration of linear magnet 32, and the amplitude of vibration, the type of motion experienced by rotating magnet 34 may also depend on factors such as the sizes and magnetic strengths of the linear and rotating magnets 32, 34.

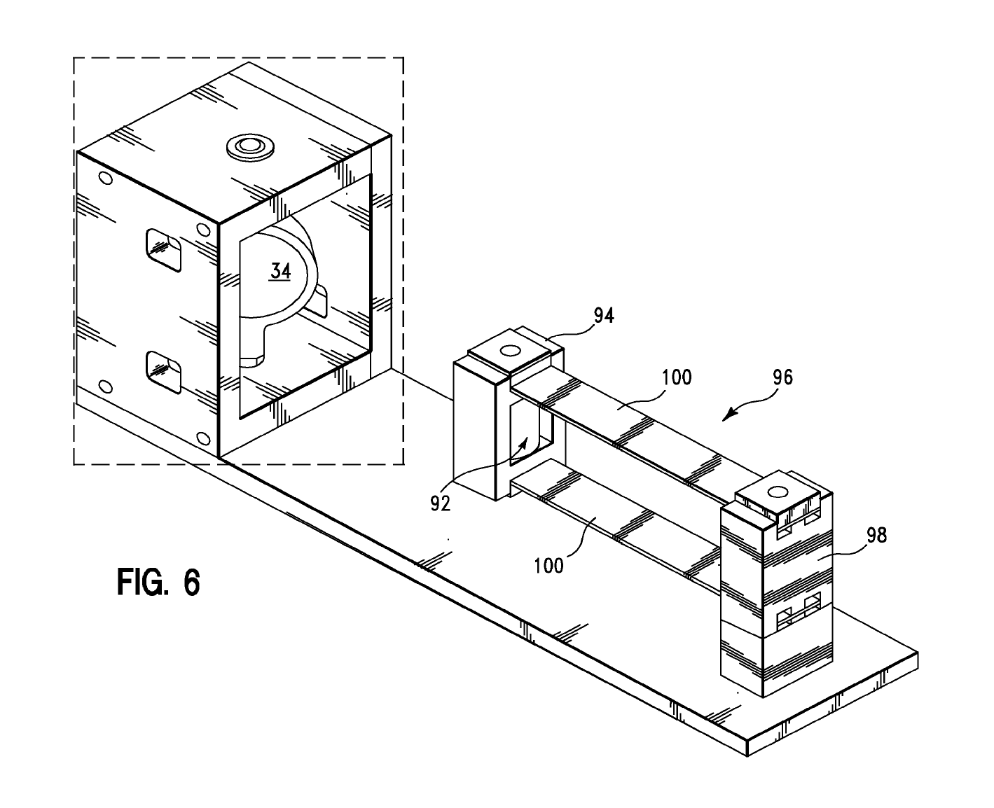

In prototype 30 linear magnet 32 was mounted to single cantilever beam 36, providing vibration substantially parallel to axis of rotation 52 of rotating magnet 34. In another embodiment, linear magnet 92 is mounted in linear magnet holder 94 which is mounted on parallelogram cantilever beam 96 which is mounted on parallelogram spring base mount 98, as shown in FIG. 6 to provide linear magnet 92 with more nearly linear vibratory motion. In this case cantilever springs 100, parallelogram cantilever beam 96, and linear magnet 92 vibrate more nearly parallel to axis of rotation 52 of rotating magnet 34.

In prototype 30, two coils 62 adjacent rotating magnet 34 had their coil axes perpendicular to the axis of rotation 52 of rotating magnet 34, as shown in FIG. 3. Coils 62 had a coil inner diameter and rotating magnet 34 had a magnet outer dimension. The coil inner diameters were sufficiently larger than the magnet outer dimension so rotating magnet 34 could move freely within coil 62.

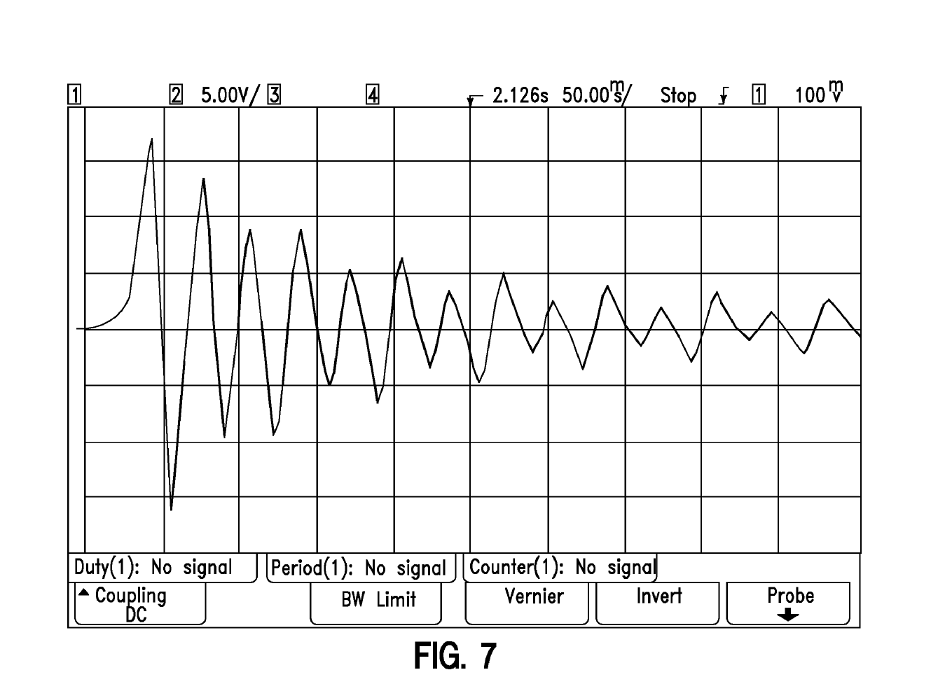

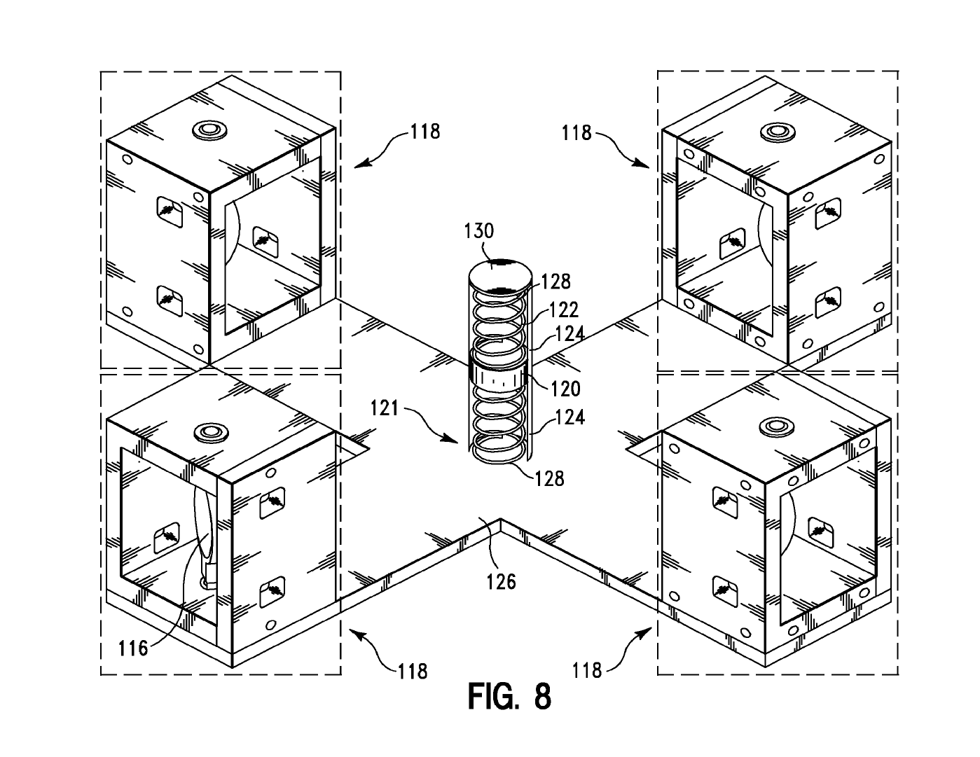

Rotation of rotating magnet 34 induced a current in each of two coils 62, as shown in FIG. 7. Coils 62 can be connected in series so as to provide a higher voltage or in parallel to provide a higher current. The present applicant measured the power produced in both of these configurations.

In another embodiment, two or more rotating magnets 116, each in its own rotating magnet assembly 118, can be positioned so motion of single linear magnet 120 within compression spring assembly 121 causes rotation of all rotating magnets 116, as shown in FIG. 8. For each of rotating magnets 116, as linear magnet 120 vibrates, a position in its motion is reached that causes that rotating magnet 116 to flip.

Alternatively, two or more linear magnet assemblies 121 can be positioned so motion of single rotating magnet 116 causes oscillation of all linear magnets 120 in those linear magnet assemblies 121, as would be indicated in FIG. 8 if rotating magnet assemblies 118 and linear magnet assemblies 121 took each other's positions.

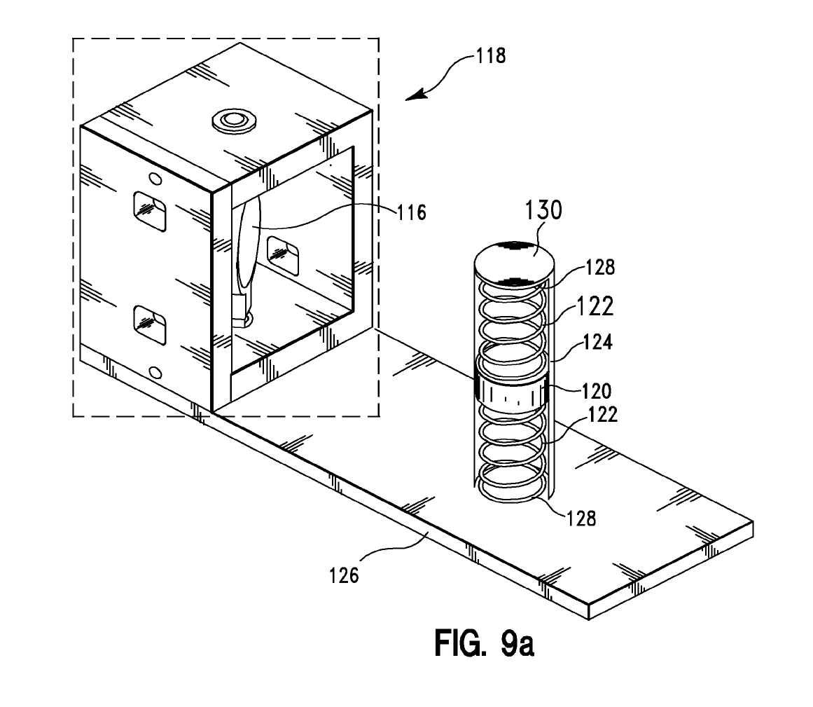

In another example of this embodiment of “substantially-linear motion,” linear magnet 120 is constrained by one or more compression springs 122 and spring guide 124 as shown in FIGS. 8 and 9a. Spring guide 124 may be a stationary tube. Linear magnet 120 moves up and down in spring guide 124 subject to vibration of the substrate or mounting plate 126 on which spring guide 124 is mounted. A pair of compression springs 122 can be used, one above and one below linear magnet 120, as shown in FIGS. 8 and 9a. If spring guide 124 is straight, spring guide 124 provides that linear magnet 120 moves strictly along a straight line as ends 128 of compression springs 122 press against mounting plate 126 and spring guide 128.

Other kinds of springs can be used as well, such as flat diaphragm springs 136, as shown in FIG. 9b. In one embodiment, magnet holder 138 holds linear magnet 140 and a pair of diaphragm springs 136. This assembly is mounted in diaphragm assembly holder 142 shown in FIG. 9c. Diaphragm assembly holder 142 includes annular diaphragm spring notches 144 that hold diaphragm springs 136 in position. Diaphragm assembly holder caps 146 permit diaphragm springs 136 to oscillate while held in position in the diaphragm assembly holder 142. Similar to compression springs 122 and spring guide 124 of FIGS. 8 and 9a, diaphragm assembly holder 142 can be mounted to vibrating mounting plate 126 of a structure, such as a machine, as shown in FIG. 9a.

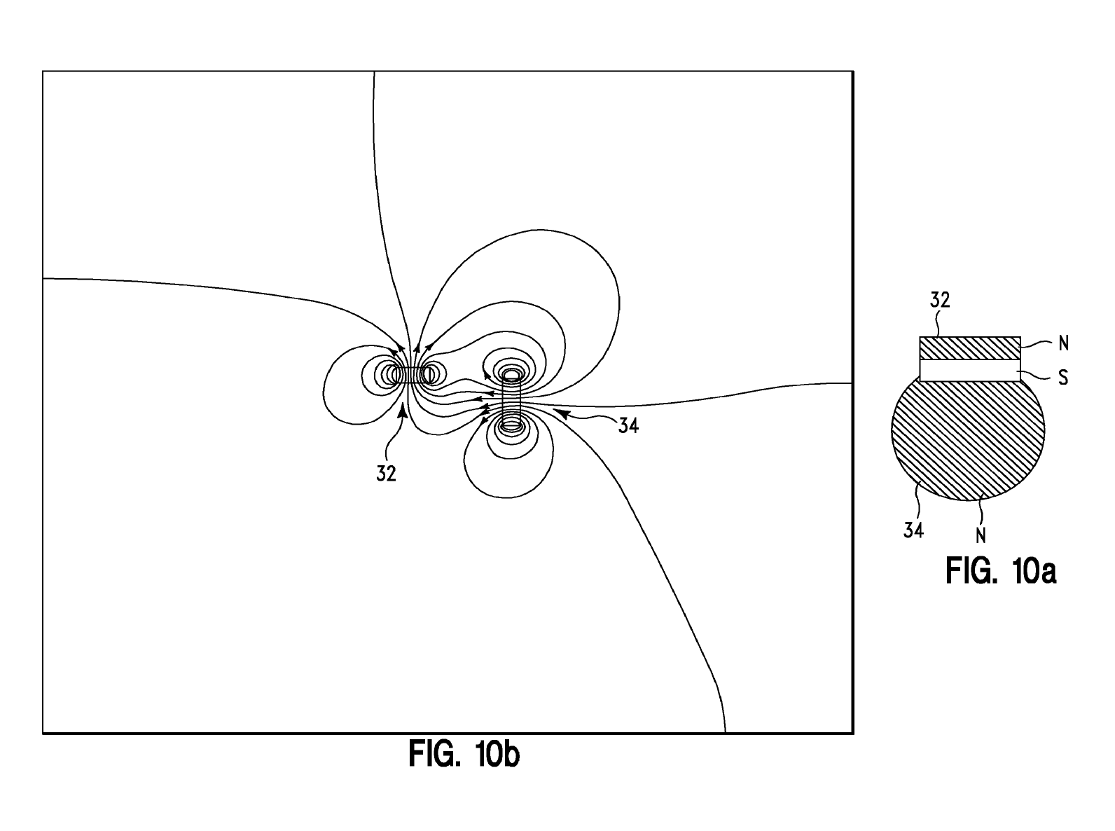

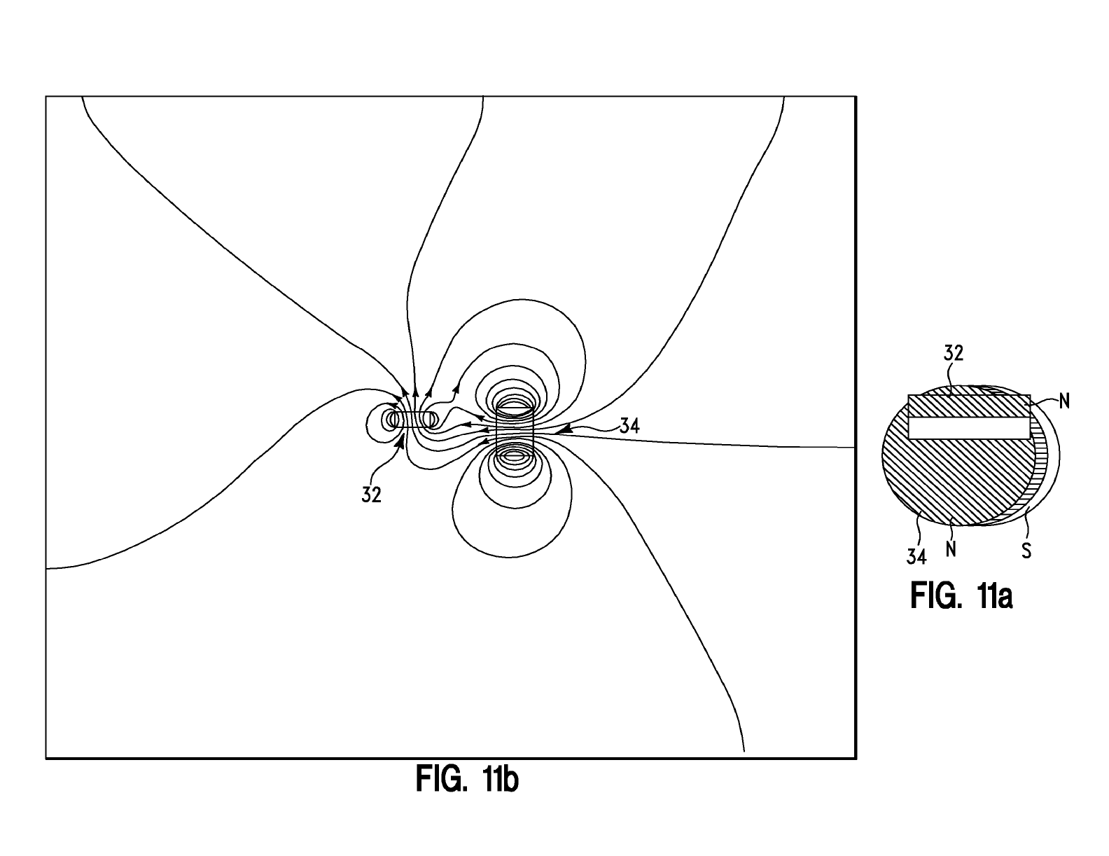

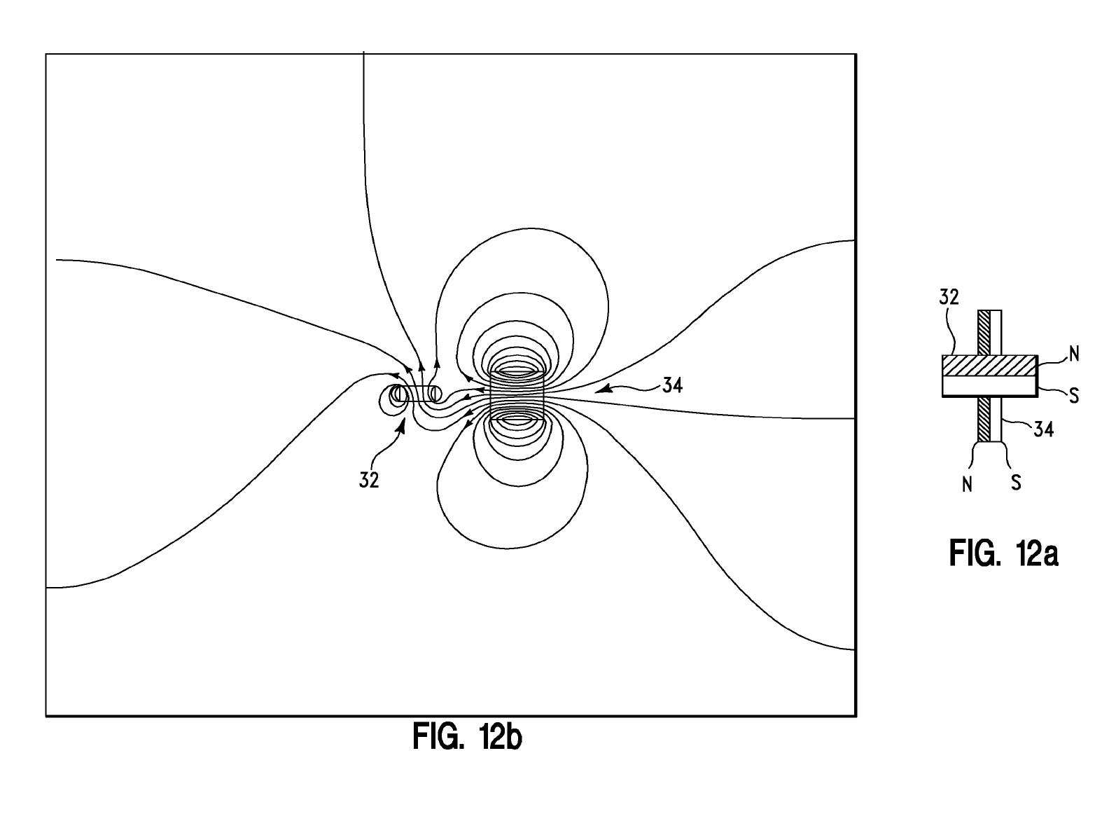

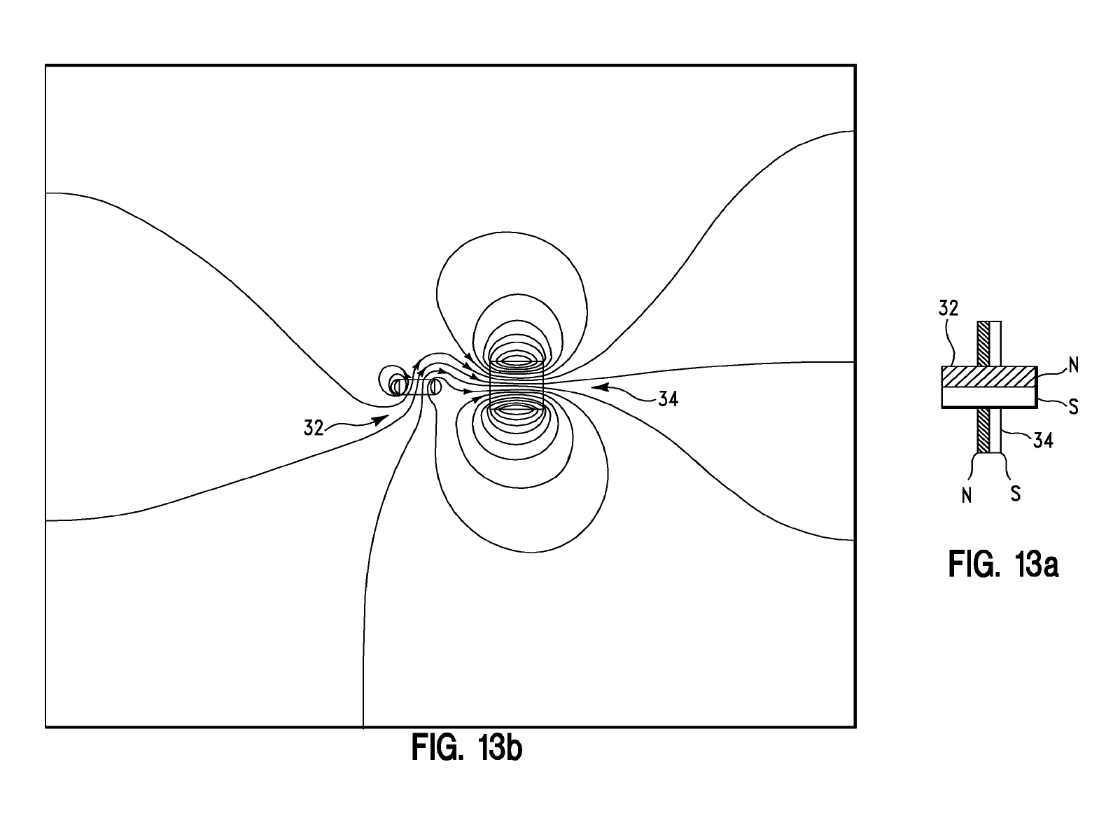

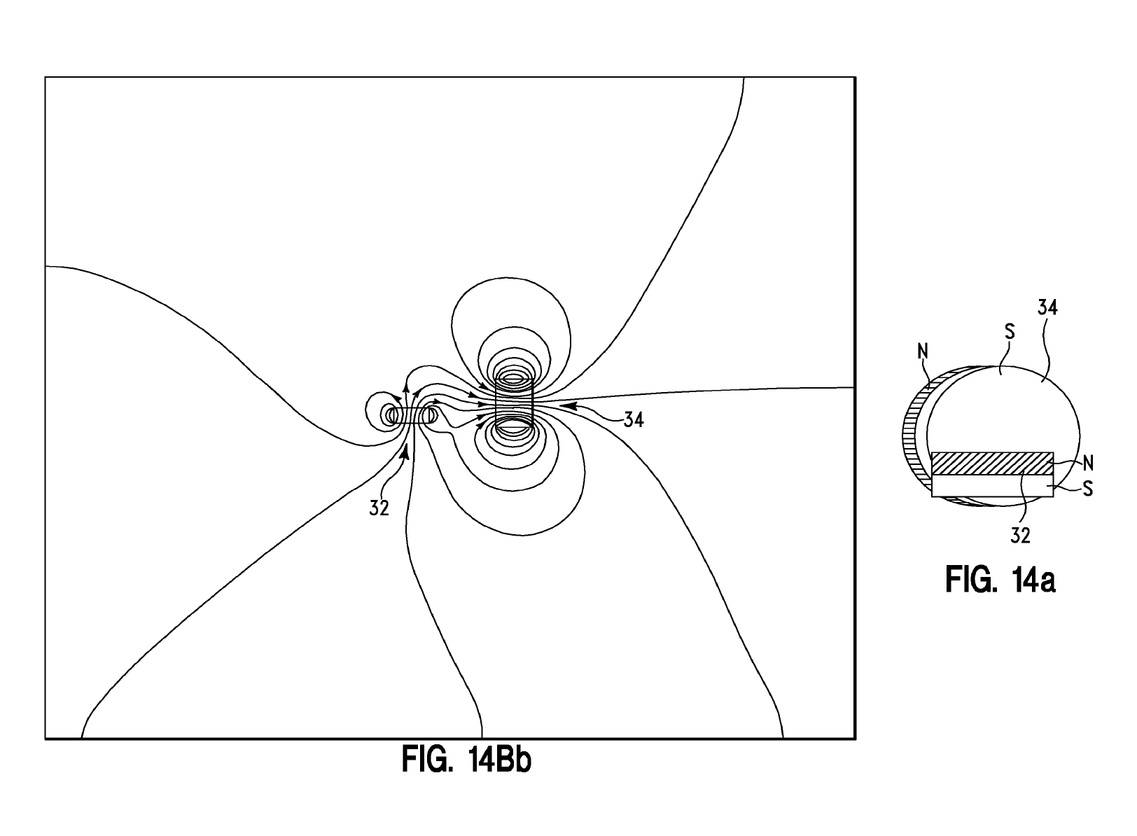

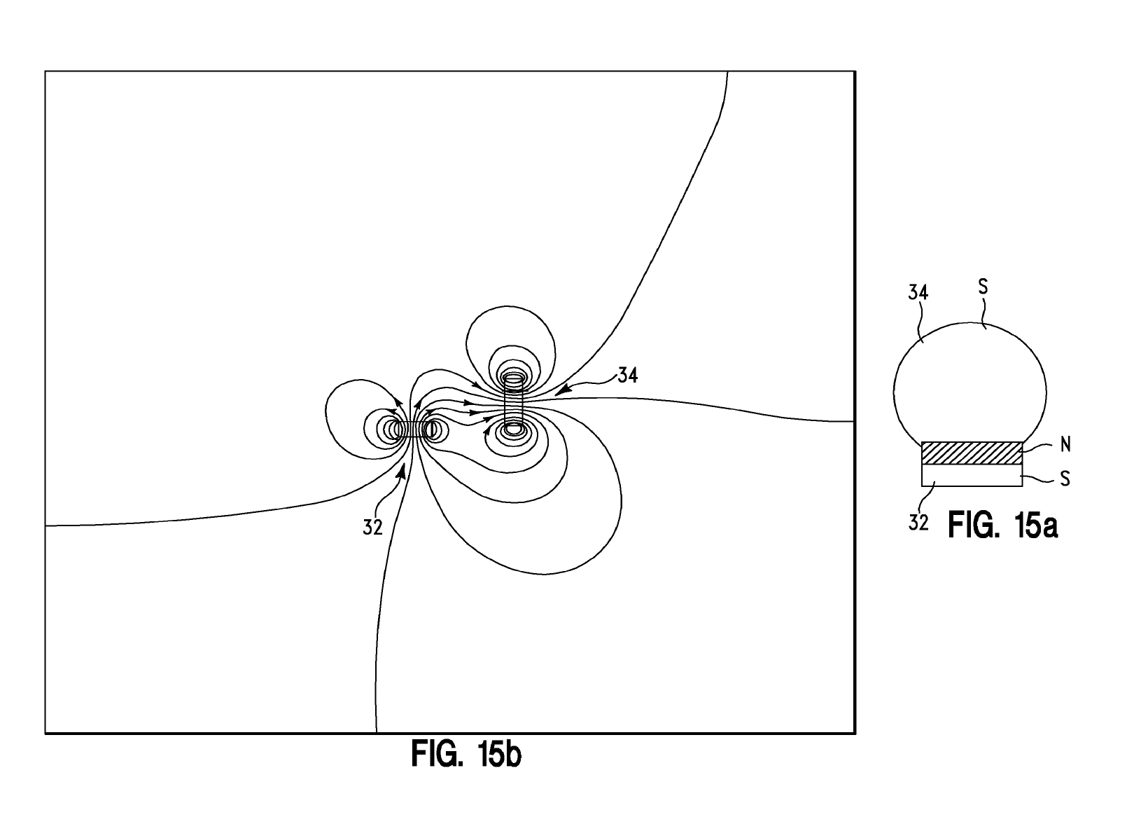

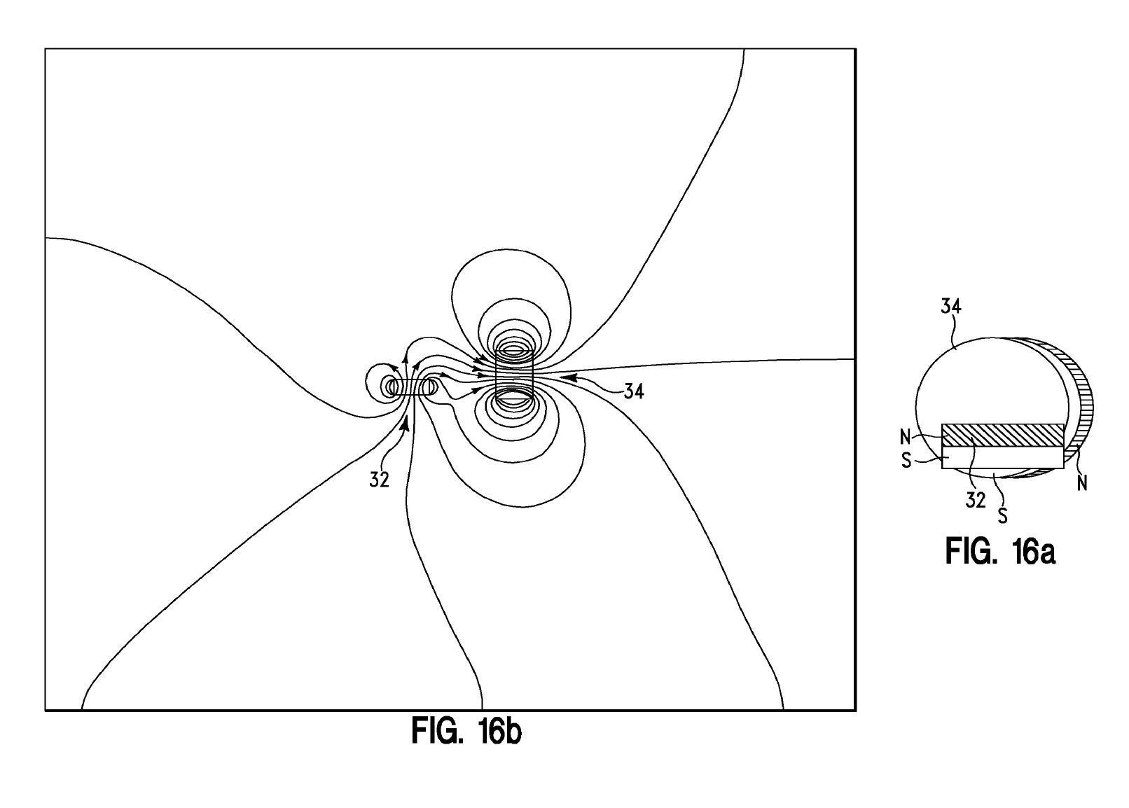

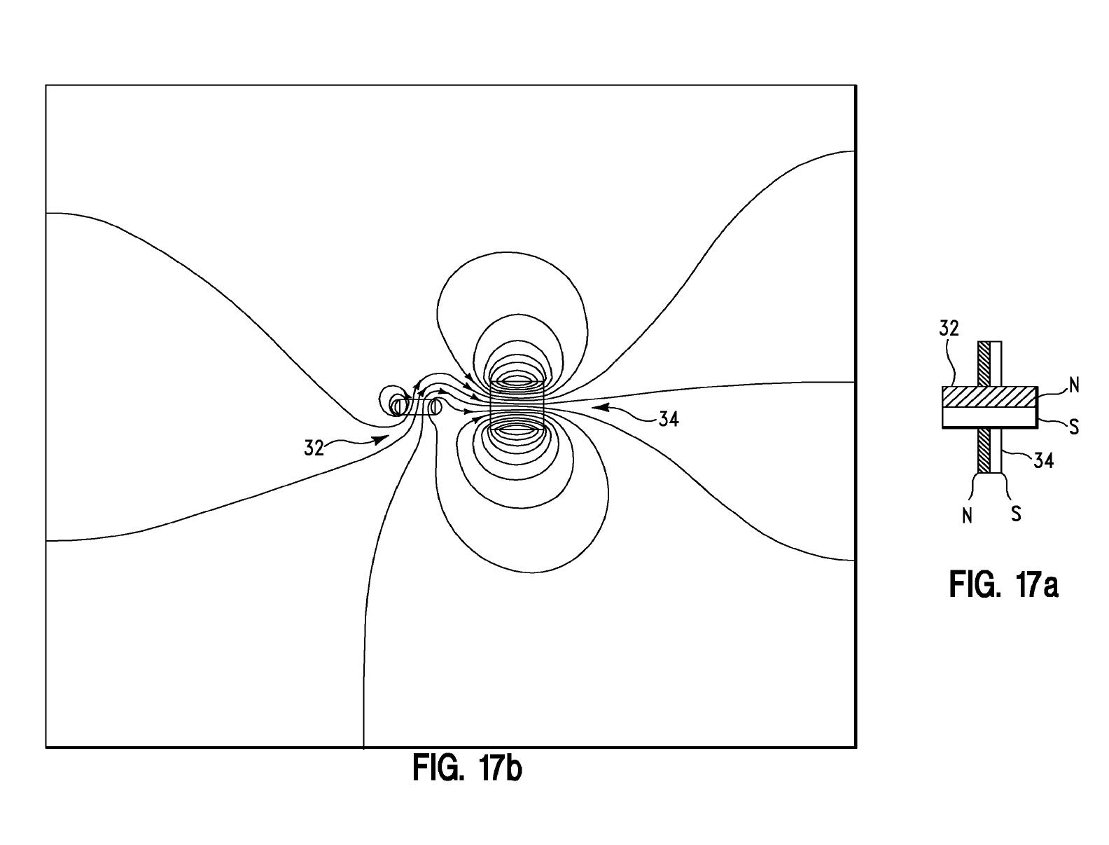

A time sequence in FIGS. 10a, 10b to 20-a, 20b indicates how the vibration of linear magnet 32 caused rotation of rotating magnet 34. The eleven sequential end views in FIGS. 10a-20a are of the apparatus of FIG. 1, sighting from cantilever beam support member 38 along cantilever beam 36 toward linear magnet 32 and behind it rotating magnet 34. These end views show linear magnet 32 starting at its highest vertical position and moving to its lowest position and back to its highest. All these movements have linear magnet 32 moving in a direction substantially parallel to axis 52 of rotating magnet 34. The observations were made by pushing linear magnet 32 up and down by hand and watching the corresponding rotation of rotating magnet 34.

Linear magnet 32, in this example, has its north pole always facing up. When linear magnet 32 was at its highest vertical position, as shown in FIG. 10a, coupling with rotating magnet 34 provided the strongest magnetic field below linear magnet 32 so rotating magnet 34 oriented with its north pole directly facing toward the downward facing south pole S of linear magnet 32. The strength of the magnetic field is illustrated in the side view of FIG. 10b, in which field lines of the interacting magnets are shown along with the relative height of linear magnet 32 and the orientation of rotating magnet 34. The orientation of rotating magnet 34 is indicated in FIGS. 10b-19b by the relative width of rotating magnet 34. In FIG. 10b rotating magnet 34 is narrowest because we are viewing it from the side with its north pole directly facing linear magnet 32. While in this set of figures the field lines appear to all exist in the plane of the paper, actually the field lines extend both into the paper and above the paper.

Similarly, when linear magnet 32 has descended to its lowest vertical position, as shown in FIG. 15a, coupling with rotating magnet 34 provides the strongest magnetic field above linear magnet 32 so rotating magnet 34 orients with its south pole S directly facing toward the upward facing north pole N of linear magnet 32. The strength of the magnetic field is illustrated in the side view of FIG. 15b. in which rotating magnet 34 is again narrowest because we are viewing it from the side, but this time with its south pole directly facing linear magnet 32.

Intermediate positions between these extremes are shown in FIGS. 11a, 11b to 14a, 14b. When linear magnet 32 had descended a short distance from its highest vertical position, as shown in FIG. 11a, the present applicant found that rotating magnet 34 turned through a small angle, as shown in FIG. 11a, orienting with its north pole mostly facing toward the downward facing south pole S of linear magnet 32. Having partially twisted, the field between the north pole N of linear magnet 32 and the south pole of rotating magnet 34 is stronger than that between the south pole S of linear magnet 32 and the north pole of rotating magnet 34, as shown in FIG. 11b. Rotating magnet 34 is wider than in FIG. 10b because we are viewing it from the side, and this time rotating magnet 34 has rotated to partially expose a larger projection in the side view.

The result of further descent by linear magnet 32 is shown in FIGS. 12a, 12b in which linear magnet 32 has descended to a level just above the center of rotating magnet 34. Slightly further descent, shown in FIGS. 13a, 13b results in linear magnet 32 descending to a level just below the center of rotating magnet 34. In FIGS. 12b and 13b rotating magnet 34 is at its widest because we are viewing it from the side, and rotating magnet 34 has rotated so its north pole is facing sideways to linear magnet 32 to expose the largest projection in the side view.

When linear magnet 32 further descended, as shown in FIGS. 14a, 14b, rotating magnet 34 further turned, now orienting with its south pole mostly facing toward the upward facing north pole N of linear magnet 32. Rotating magnet 34 is less wide than in FIG. 13b because rotating magnet 34 has further rotated to partially expose a smaller projection in the side view.

FIGS. 16a, 16b to 19a, 19b show possible positions of rotating magnet 34 as the linear magnet now rises from the lowest position shown in FIGS. 15a, 15b. In these figures, rotating magnet 34 appears to have sufficient momentum to continue rotating in the same direction as its previous rotation keeping in step with the ascent of linear magnet 32.

Moving linear magnet 32 by hand applicants found that slow speed linear movement near the center line of rotating magnet 34 provided high speed rotation or flipping of rotating magnet 34, and this high speed flipping does not depend on speed of linear magnet 32. Rotating magnet 34 was seen to be sensitive even to slow movement of linear magnet 32, and a slight movement of linear magnet 32 caused a quick flip in rotating magnet 34. They found that prototype 30 worked well to convert linear movement into rotational movement. They recognized that prototype 30 could also convert rotational movement into linear movement, such as vibration, as further described in several embodiments herein below.

In one embodiment, an AC current is supplied to the coil surrounding rotating magnet 34 of FIG. 1. The current in the this coil causes the rotating magnet to flip. Rotation of rotating magnet 34 causes linear magnet 32 to move. If linear magnet 32 is mounted to a part, such as a conveyor belt, as shown in FIG. 5, the motion of linear magnet 32 would cause the conveyor belt to move.

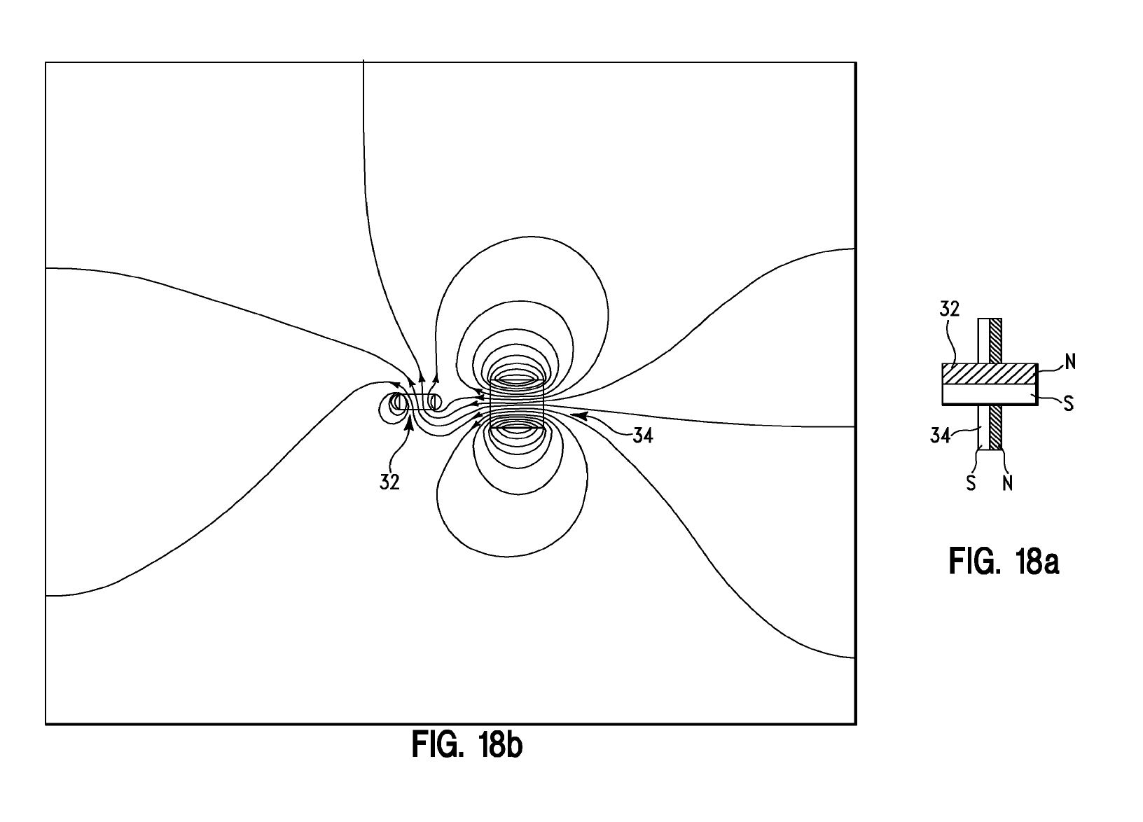

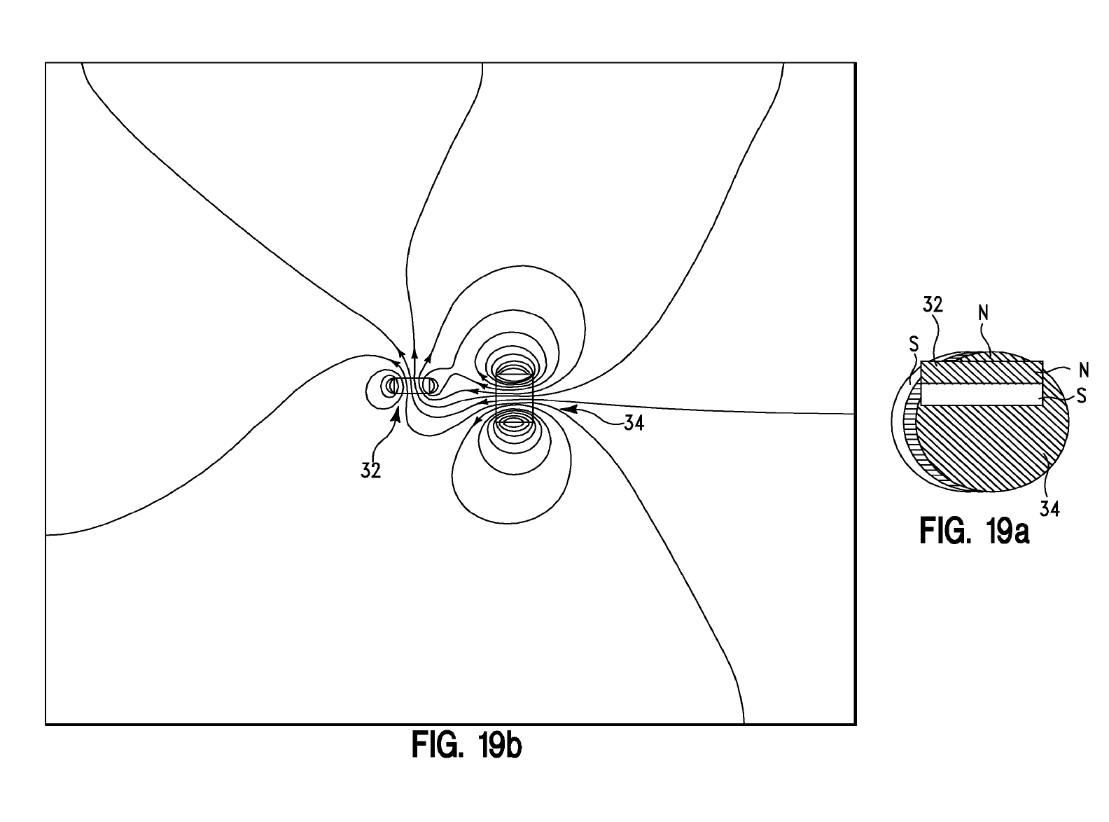

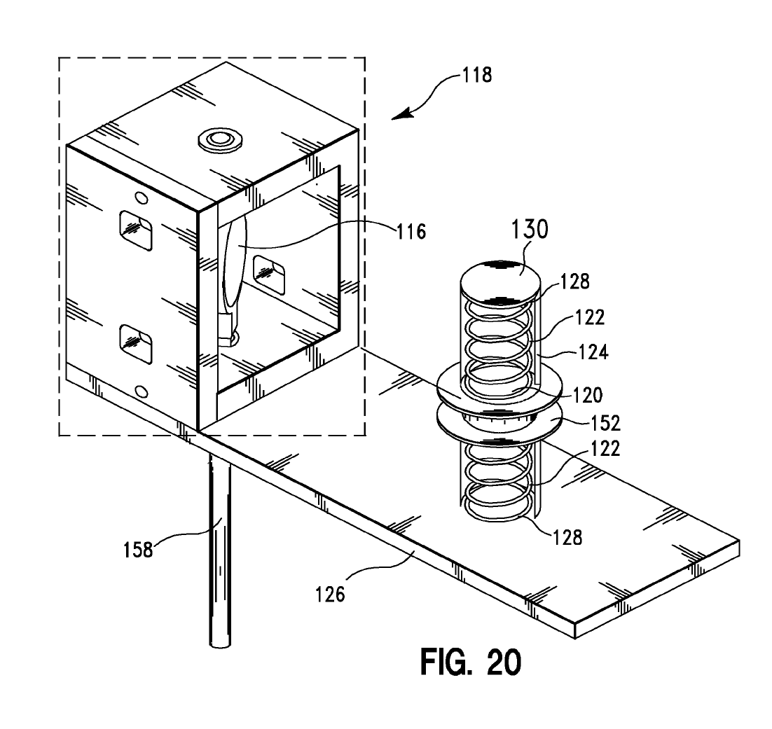

In one embodiment, coil 150 on coil bobbin 152 extends around linear magnet 120, as shown in FIG. 20. Linear magnet 120 is constrained to move within a spring guide 124. Compression springs 122 located in spring guide 124 provide for oscillation of linear magnet 120. Vibration of mounting plate 126 on which linear magnet 120 and compression springs 122 are mounted causes linear magnet 120 to oscillate within spring guide 124 and within coil 150 surrounding spring guide 124. The oscillation of linear magnet 120 causes an AC current to be generated within coil 150.

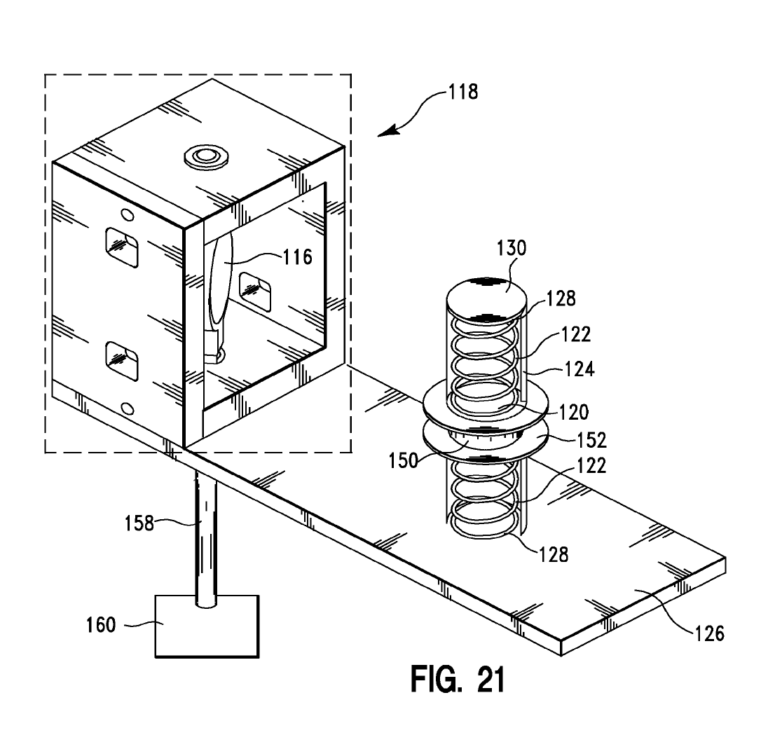

In other embodiments, extended bearing rod 158 is connected to rotating magnet 116 of FIGS. 20-23. In one embodiment, the extended bearing rod shown is connected to a rotating substrate, such as motor 160, as shown in FIG. 21. The motor causes rotation of extended bearing rod 158. The rotation of extended bearing rod 158 causes rotating magnet 116 to rotate. The rotation of rotating magnet 116 causes linear magnet 120 to vibrate. The vibration of linear magnet 116 within coil 150 surrounding spring guide 124 and linear magnet 116 causes electrical power generation in coil 150, harvesting energy of motor 160.

In another embodiment, two or more linear magnets 120, each with its own coil 150 are positioned so rotation of a single rotating magnet 116 of FIG. 21 causes substantially linear motion of all linear magnets 120 and generation of electrical power in all of their coils 150. While FIG. 21 shows one such linear magnet 120 the others can be similarly positioned on mounting plate 126 so their substantially linear motion is parallel to the axis of rotation of rotating magnet 116.

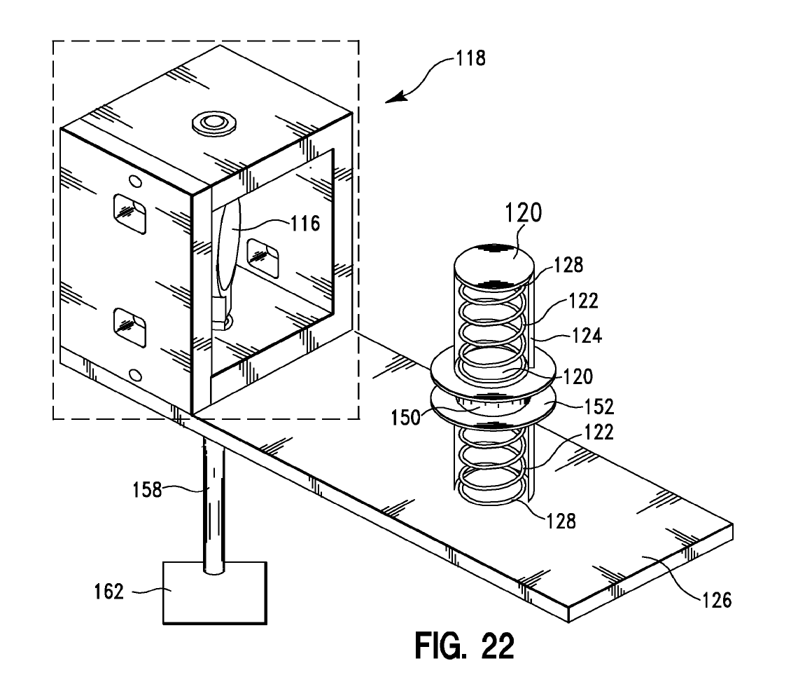

In another embodiment, generator or permanent magnet motor 162 is connected to extended bearing rod 158, as shown in FIG. 22. Vibrating mounting plate 126, such as by connecting it to a vibrating piece of machinery, causes linear magnet 120 to oscillate. Oscillation of linear magnet 120 causes rotating magnet 116 to flip. Rotation of rotating magnet 116 causes extended bearing rod 158 to rotate. Rotation of extended bearing rod 158 causes generator or permanent magnet motor 162 to generate electricity, harvesting energy of the vibrating machinery.

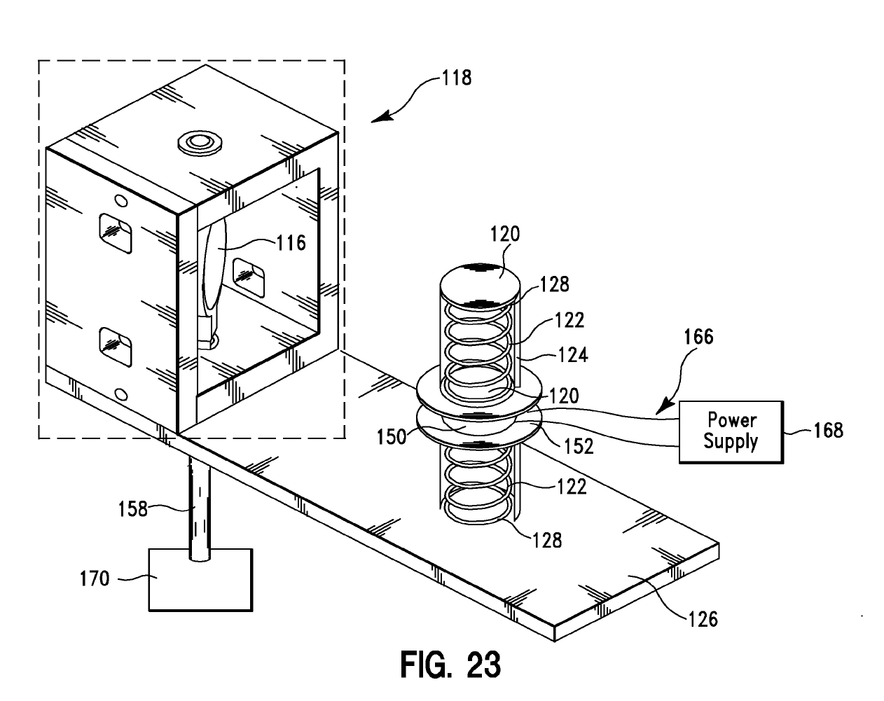

In another embodiment, an AC current is supplied along wires 166 from power supply 168 to coil 150 surrounding linear magnet 120, as shown in FIG. 23. The current in coil 150 causes linear magnet 120 to oscillate. Oscillation of linear magnet 120 causes rotating magnet 116 to rotate. If rotating extended bearing rod 158 is mounted to device 164, the motion of rotating magnet 116 would cause device 170 to rotate.

While the disclosed methods and systems have been shown and described in connection with illustrated embodiments, various changes may be made therein without departing from the spirit and scope of the invention as defined in the appended claims.

1. A device, comprising a first magnet, a second magnet, and a coil, wherein said first magnet is constrained to move in substantially-linear motion, wherein said second magnet is mounted to move in rotational motion, wherein said first and second magnets are positioned so said substantially-linear motion of said first magnet causes rotation of said second magnet, wherein said coil is adjacent said second magnet, wherein said rotation of said second magnet induces a current in said coil.

2. A device as recited in claim 1, wherein said rotational motion of said second magnet includes an axis of rotation, wherein said substantially-linear motion of said first magnet is substantially parallel to said axis of rotation.

3. A device as recited in claim 2, wherein said first magnet is mounted on a cantilever beam, wherein said beam is mounted for vibration substantially parallel to said axis of rotation.

4. A device as recited in claim 3, wherein said first magnet is mounted on a parallelogram cantilever beam.

5. A device as recited in claim 3, further comprising a substrate subject to vibration at a substrate frequency, wherein said cantilever beam includes an adjustable element for matching natural frequency of vibration of said cantilever beam to said substrate frequency.

6. A device as recited in claim 2, wherein said first magnet is mounted in a spring guide with a spring wherein said spring guide is mounted parallel to said axis of rotation.

7. A device as recited in claim 6, wherein said spring guide includes a tube.

8. A device as recited in claim 2, wherein said first magnet is mounted with a flat diaphragm spring.

9. A device as recited in claim 2, wherein said coil has a coil axis, wherein said coil axis is perpendicular to said axis of rotation.

10. A device as recited in claim 2, wherein said coil has a coil inner diameter and wherein said second magnet has a magnet dimension, wherein said coil inner diameter is sufficiently larger than said magnet dimension so said second magnet can rotate freely within said coil.

11. A device as recited in claim 1, further comprising a load electrically connected to said coil, wherein said load is powered by said current.

12. A device as recited in claim 1, further comprising a plurality of coils adjacent said second magnet, wherein rotation of said second magnet induces a current in each said coil.

13. A device as recited in claim 1, further comprising a plurality of second magnets positioned so motion of said first magnet causes rotation of said plurality of second magnets, wherein a coil is adjacent each said second magnet.

14. A device as recited in claim 1, wherein said second magnet is mounted with a low friction bearing.

15. A device for harvesting energy, comprising a coil and a system for non-contact converting substantially-linear motion into rotational motion, wherein said coil is positioned to convert said rotational motion into electricity.

16. A device as recited in claim 15, wherein said non-contact system includes a first magnet and a second magnet, wherein said first magnet is constrained to move in substantially-linear motion, wherein said second magnet is mounted to move in rotational motion, wherein said first and second magnets are positioned so said substantially-linear motion of said first magnet causes rotation of said second magnet, wherein said coil is adjacent said second magnet, wherein rotation of said second magnet induces a current in said coil.

17. A device for harvesting energy, comprising a coil and a system for non-contact converting rotational motion into substantially-linear motion, wherein said coil is positioned to convert said linear motion into electricity.

18. A device as recited in claim 17, wherein said non-contact system includes a first magnet and a second magnet, wherein said first magnet is constrained to move in substantially-linear motion, wherein said second magnet is mounted to move in rotational motion, wherein said first and second magnets are positioned so said rotational of said second magnet causes substantially-linear motion of said first magnet, wherein said coil is adjacent said first magnet, wherein said substantially-linear motion of said first magnet induces a current in said coil.

19. A device as recited in claim 18, further comprising a plurality of first magnets and a plurality of coils, wherein said plurality of first magnets and said second magnet are positioned so said rotation of said second magnet causes substantially-linear motion of said plurality of first magnets, wherein said coils are adjacent said first magnets, wherein said substantially-linear motion of said first magnets induces a current in said coils.

20. A device, comprising a coil, a first magnet, a second magnet, wherein said first magnet is constrained to move in substantially-linear motion, wherein said second magnet is mounted to move in rotational motion, wherein said first and second magnets are positioned so at least one from the group consisting of said substantially-linear motion of said first magnet causes rotation of said second magnet and said rotation of said second magnet causes said substantially-linear motion of said first magnet, wherein said coil is positioned adjacent at least one from the group consisting of said first magnet and said second magnet.

21. A device as recited in claim 20, wherein said coil is positioned adjacent said first magnet, wherein providing a current in said coil causes said first magnet to move in said substantially linear motion.

22. A device as recited in claim 21, wherein said first and second magnets are positioned so said first magnet moving in said substantially linear motion causes said rotation of said second magnet.

23. A device as recited in claim 20, wherein said coil is positioned adjacent said first magnet, wherein providing said first magnet to move in said substantially linear motion induces a current in said coil.

24. A device as recited in claim 20, wherein said coil is positioned adjacent said second magnet, wherein providing a current in said coil causes said second magnet to move in said rotating motion and wherein said second magnet moving in said rotating motion causes said linear magnet to move in said substantially linear motion.

25. A device as recited in claim 20, wherein said coil is positioned adjacent said second magnet, wherein causing said linear magnet to move in said substantially linear motion causes said second magnet to move in said rotating motion and wherein said rotating motion of said second magnet induces a current in said coil.
